(19) United States
(12) Patent Application Publication
(10) Pub. No.: US 2013/0298224 A1
(43) Pub. Date: Nov. 7, 2013

(54) ELECTRONIC DEVICE INCLUDING A FINGER SENSOR HAVING A VALID AUTHENTICATION THRESHOLD TIME PERIOD AND RELATED METHODS

(71) Applicant: Mark Allen HEILPERN, Satellite Beach, FL (US)

(72) Inventor: Mark Allen HEILPERN, Satellite Beach, FL (US)

(73) Assignee: AuthenTec, Inc., Melbourne, FL (US)

(21) Appl. No.: 13/463,210

(22) Filed: May 3, 2012

(51) Int. Cl. H04L 9/32

(52) U.S. Cl. 726/19

(57) ABSTRACT

An electronic device may include a finger sensor to sense a user's finger. The electronic device may also include a processor coupled to the finger sensor to perform multiple applications, acquire finger-matching biometric data of the user's finger from the finger sensor, and authenticate the user based upon a match between the acquired finger-matching biometric data and finger-enrollment biometric data. The processor may also start a given application, from among the applications thereof, based upon the authentication. The processor may treat the authentication as valid for a threshold time period.

### FIELD OF THE INVENTION

The present invention relates to the field of electronics, and, more particularly, to the field of finger sensors.

### BACKGROUND OF THE INVENTION

Fingerprint sensing and matching is a reliable and widely used technique for personal identification or verification. In particular, a common approach to fingerprint identification involves scanning a sample fingerprint or an image thereof and storing the image and/or unique characteristics of the fingerprint image. The characteristics of a sample fingerprint may be compared to information for reference fingerprints already in a database to determine proper identification of a person, such as for verification purposes.

A particularly advantageous approach to fingerprint sensing is disclosed in U.S. Pat. No. 5,953,441 to Setlak and assigned to the assignee of the present invention, the entire contents of which are herein incorporated by reference. The fingerprint sensor is an integrated circuit sensor that drives the user's finger with an electric field signal and senses the electric field with an array of electric field sensing pixels on the integrated circuit substrate.

U.S. Pat. No. 6,289,114 to Mainguet, which is assigned to the assignee of the present invention and is incorporated in its entirety by reference, discloses a fingerprint sensor that includes a finger sensing integrated circuit (IC). The finger sensing IC includes a layer of piezoelectric or pyroelectric material placed between upper and lower electrodes to provide electric signals representative of an image of the ridges and valleys of the fingerprint.

A particularly advantageous approach to multi-biometric fingerprint sensing is disclosed in U.S. Pat. No. 7,361,919 to Setlak, which is assigned to the assignee of the present invention and is incorporated in its entirety by reference. The Setlak patent discloses a multi-biometric finger sensor sensing different biometric characteristics of a user's finger that have different matching selectivities.

A fingerprint sensor may be particularly advantageous for verification and/or authentication in an electronic device, and more particularly, a portable device, for example. Such a fingerprint sensor may be carried by the housing of a portable electronic device, for example, and may be sized to sense a fingerprint from a single-finger. For example, the AES3400 sensor from AuthenTec, Inc. of Melbourne, Fla., the assignee of the present invention, is widely used in a variety of notebooks, desktops and PC peripherals. Other fingerprint sensors, for example, the AES850, also from AuthenTec, Inc. of Melbourne, Fla., is a multi-function smart sensor that expands touch-based functionality of touchscreen and QWERTY smartphones with a reduced impact on sensor performance or durability. Thus, a fingerprint sensor may be particularly advantageous for providing more convenient access to the electronic device without a password, for example, and, more particularly, without having to type the password, which is often time consuming. A fingerprint sensor may also be particularly advantageous for starting one or more application on the electronic device.

U.S. Patent Application Publication No. 2011/0175703 to Benkley, III discloses an electronic imager using an impedance sensor grid array mounted on or about a switch. More particularly, Benkley, III discloses a switch being incorporated into a sensor assembly that allows integration of sensor operations, such as, fingerprint sensor operations. A fingerprint sensor can be used for authentication while being used together with a power switch or navigation selection switch. The authentication may be used to access the device entirely or access different levels of information.

U.S. Patent Application Publication No. 2009/0083850 to Fadell et al. discloses an embedded authentication system in an electronic device. More particularly, Fadell et al. discloses authenticating a user via a fingerprint to provide access to resources or content that was previously not available. The electronic device may allow a user to authenticate for a particular amount of time for accessing restricted resources.

### SUMMARY OF THE INVENTION

In view of the foregoing background, it is therefore an object of the present invention to provide security and with convenient access.

This and other objects, features, and advantages in accordance with the present invention are provided by an electronic device may include a finger sensor to sense a user's finger. The electronic device may also include a processor coupled to the finger sensor. The processor may perform a plurality of applications, acquire finger-matching biometric data of the user's finger from the finger sensor, and authenticate the user based upon a match between the acquired finger-matching biometric data and finger-enrollment biometric data. The processor may also start a given application, from among the plurality thereof, based upon the authentication, and treat the authentication as valid for a threshold time period. Accordingly, the electronic device advantageously provides increased security while providing more convenient access to the given application by starting or quick launching the given application upon authentication, and maintaining the authentication for a threshold time period. In addition, the electronic device may be particularly advantageous for permitting one authentication to be available for multiple authentication operations.

The processor may treat the authentication as valid for the threshold time period while performing the given application, for example. The processor may treat the authentication as valid for the threshold time period while performing an application other than the given application in some embodiments.

The electronic device may further include a finger-operated input device carrying the finger sensor. The processor may perform at least one device function responsive to operation of the finger-operated input device. The processor may acquire the finger-matching biometric data from the finger sensor also responsive to operation of the finger-operated input device, for example. The finger-operated input device may include a pushbutton switch.

The threshold time period may be less than or equal to 30 seconds, for example. The electronic device may further include a display. And, the processor may prompt, via the display, the user to again position the user's finger on the finger sensor after expiration of the threshold time period to provide additional security. The processor may also acquire the finger-enrollment biometric data.

The electronic device may further include wireless communications circuitry coupled to the processor and for performing at least one wireless communications function. The processor may be for starting the given application based upon the authentication of a specific finger of the user, for example. The electronic device may further include a portable housing carrying the finger sensor and the processor, for example.

A method aspect is directed to a method of authenticating a user of an electronic device that may include a finger sensor and processor coupled thereto. The method may include using the processor to perform a plurality of applications. The processor may also be used to acquire finger-matching biometric data of the user's finger from the finger sensor, authenticate the user based upon a match between the acquired finger-matching biometric data and finger-enrollment biometric data, and start a given application, from among the plurality thereof, based upon the authentication. The processor may further be used to treat the authentication as valid for a threshold time period.

### BRIEF DESCRIPTION OF THE DRAWINGS

FIG. 1 is a plan view of an electronic device according to the present invention.

FIG. 2 is a schematic block diagram of the electronic device of FIG. 1.

FIG. 3 is a flow chart of a method of authenticating a user according to the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

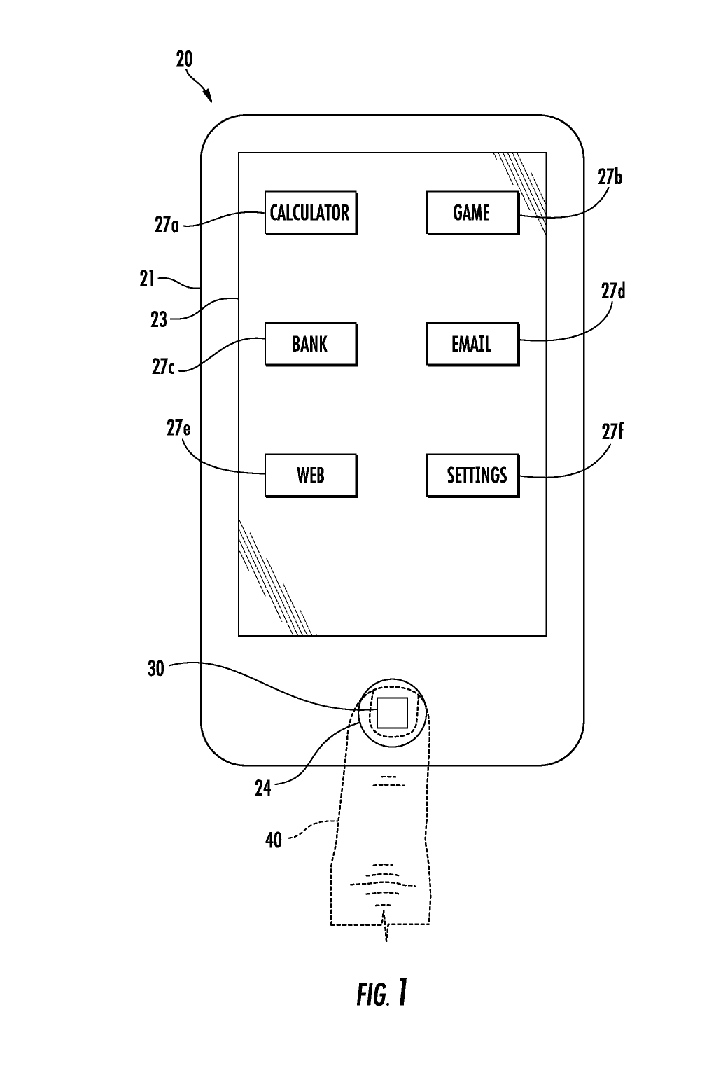

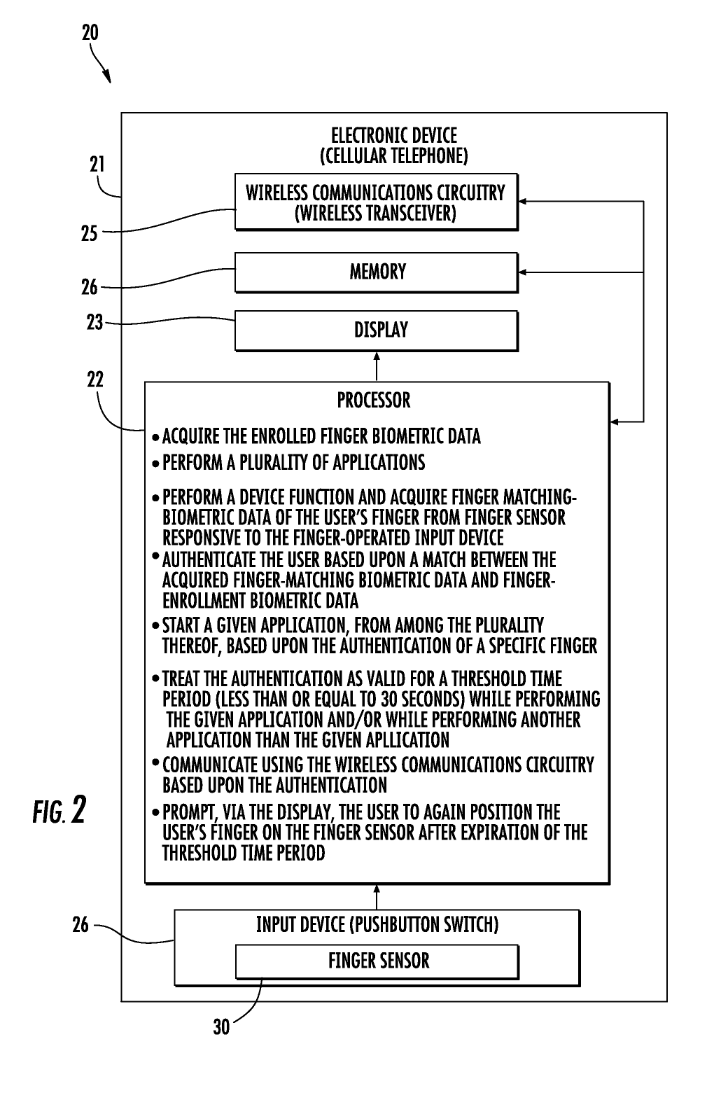

Referring now initially to FIGS. 1 and 2, an electronic device 20 illustratively includes a portable housing 21 and a processor 22 carried by the portable housing. The electronic device 20 is illustratively a mobile wireless communications device, for example, a cellular telephone. The electronic device 20 may be another type of electronic device, for example, a tablet computer, laptop computer, etc.

A wireless transceiver 25 is also carried within the housing 21 and coupled to the processor 22. The wireless transceiver 25 cooperates with the processor 22 to perform at least one wireless communications function, for example, for the transmission and reception of voice and/or data. In some embodiments, the electronic device 20 may not include a wireless transceiver 25 or other wireless communications circuitry.

A display 23 is also carried by the portable housing 21 and is coupled to the processor 22. The display 23 may be a liquid crystal display (LCD), for example, or may be another type of display, as will be appreciated by those skilled in the art.

The processor 22 performs a plurality of applications. More particularly, the processor may execute one or more applications based upon pressing respective display icons 27a-27f on the display 23. The icons include a web browser icon 27e a game icon 27b, a banking application 27c, an email application icon 27d, a calculator application icon 27a, and settings application icon 27f. Each application may be a third party application, for example, downloaded from a third-party, or alternatively may be an application native to the electronic device 20, for example, pre-loaded by the manufacturer.

A finger-operated input device, illustratively in the form of a pushbutton switch 24, is also carried by the portable housing 21 and is coupled to the processor 22. The pushbutton switch 24 cooperates with the processor 22 to perform a device function in response to the pushbutton switch. For example, a device function may include a powering on or off of the electronic device 20, initiating communication via the wireless communications circuitry 25, and/or performing a menu function.

More particularly, with respect to a menu function, the processor 22 may change the display 23 to show a menu of available applications based upon pressing of the pushbutton switch 24. In other words, the pushbutton switch 24 may be a home switch or button, or key. The processor 22 may also toggle between applications based upon pressing of the pushbutton switch 24. Of course, other device functions may be performed based upon the pushbutton switch 24. In some embodiments, the finger-operated input device 24 may be a different type of finger-operated input device, for example, forming part of a touch screen display. Other or additional finger-operated input devices may be carried by the portable housing 21.

A finger sensor 30 is carried by the pushbutton switch 24 to sense a user's finger 40. The finger sensor 30 is carried by the pushbutton switch 24 so that when a user contacts and/or presses downward on the pushbutton switch, finger-matching biometric data from the user's finger 40 is acquired. Finger biometric data may include minutae data, ridge and/or valley fingerprint image data, ridge flow data, finger pore data, etc. For example, the finger sensor 30 may be a finger sensor as described in U.S. Pat. No. 5,953,441 to Setlak and/or as described in U.S. Pat. No. 6,927,581 to Gozzini, and assigned to the assignee of the present invention and the entire contents of which are herein incorporated by reference.

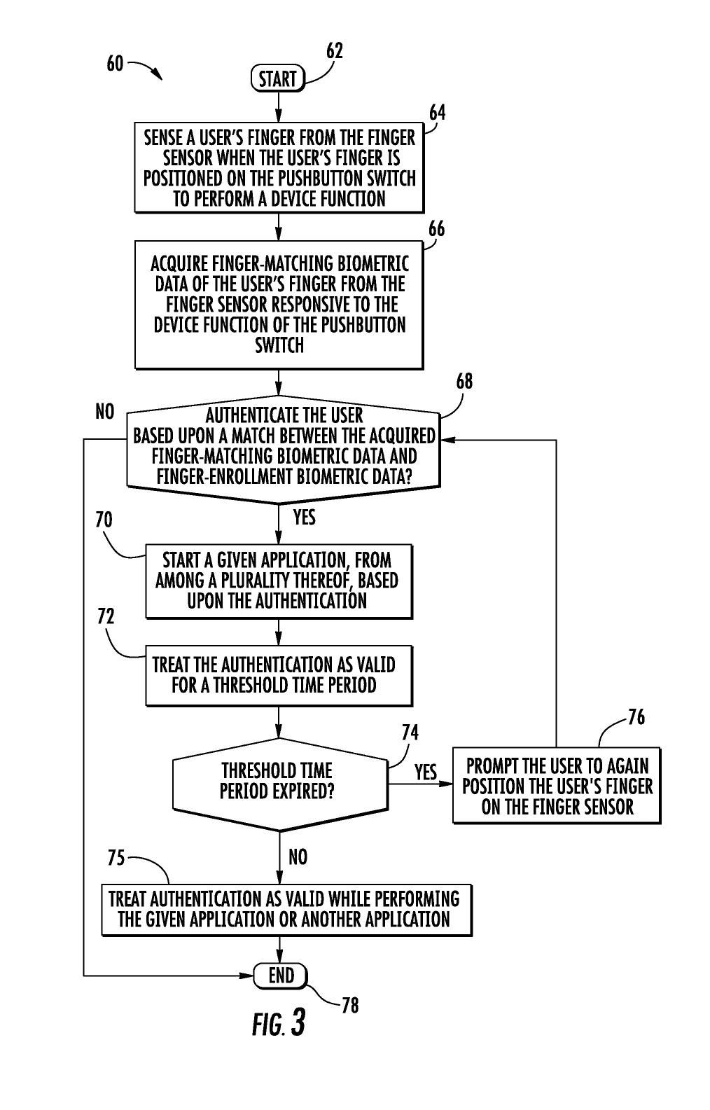

Referring now additionally to the flowchart 60 in FIG. 3, further details of operation of the electronic device 20 are now described. Beginning at Block 62, the processor 22 cooperates with the finger sensor 30 to sense a user's finger 40 from the finger sensor when the user's finger is positioned on the pushbutton switch 24 to perform a device function. (Block 64). The processor 22 acquires finger biometric data from the finger sensor 30 responsive to the pushbutton switch 24, for example, contact with or pressing of the pushbutton switch (Block 66). In other words, each time the user presses the pushbutton switch 24, the processor 22 acquires finger-matching biometric data. From the perspective of the user, the acquisition of the finger-matching biometric data may be transparent. In particular, the finger-matching biometric data may be acquired during normal operation of the pushbutton switch 24 while performing device functions.

The processor 22 authenticates the user based upon a match between the acquired finger-matching biometric data and finger-enrollment biometric data, also stored in a memory 26 coupled to the processor (Block 68). If the user is not authenticated, for example, if there is no match, the authentication method ends at Block 78. The processor 22 acquires the finger-enrollment biometric data for a given user's finger 40 prior to authentication. For example, the processor 22 may acquire the finger-enrollment biometric data upon an initial setup of the electronic device 20. In some embodiments, the processor 22 may acquire the finger-enrollment biometric data based upon input from the user, for example, if the user wishes to enroll finger-enrollment biometric data associated with another finger, or add finger-enrollment biometric data of another authorized user's finger.

The processor 22 may also start or launch a given application, from among the plurality thereof, based upon the authentication (Block 70). In other words, the processor 22 may perform a quick-launch operation of the given application based upon the authentication. Additionally, in some embodiments, the processor 22 may perform additional operations with respect to the given application, for example, similar to a macro function, based upon the authentication, and based upon a specific finger of the user. For example, a user's middle finger may start the game application, while the user's index finger may start the bank application. Further details of starting one or more applications are provided in U.S. Pat. No. 7,697,729 to Howell et al., assigned to the present assignee, and the entire contents of which are herein incorporated by reference.

After the match, the processor 22 treats the authentication as valid for a threshold time period (Block 72). For example, the threshold time period may be set to be less than or equal to thirty seconds.

During the threshold time period, i.e., if the threshold time period has not expired (Block 74), the processor 22 treats the authentication as valid while performing the application (Block 75). For example, if a banking application for communicating with a remote bank computer, for example, has been started based upon the authentication of the user, the same banking application would typically request another authentication via the finger sensor 30 to log in or perform some other application function, for example, transfer money. However, the processor 22, which is treating the previous authentication as valid, does not request another authentication. In the banking application example, the processor 22 uses the valid authentication to log into the banking application without the processor again prompting the user to position the user's finger 40 on the finger sensor 30.

During the threshold time period, the processor 22 may also treat the authentication as valid while performing another application (Block 75). For example, a web browser application that has teen started based upon the authentication of the user may open or perform another application. The processor 22 may use the authentication treated as valid with the newly performed or opened application. More particularly, the processor 22 may use the valid authentication to authenticate the user to the newly performed or opened application.

The pushbutton switch 24 may be used to exit the given application. Another application may be started, which may require authentication. For example, if a user exits a gaming application that was started based upon the authentication, and then opens or starts a banking application, the authentication will be valid for authenticating the user to the banking program so long as the threshold time period has not expired.

The processor 22 treating the authentication as valid for the threshold time period may be particularly advantageous, for example, for reducing the number of times a user is to be authenticated. More particularly, the number of times a user would have to position the user's finger 40 on the finger sensor 30 may be reduced to thus improve the user's overall experience. This may be particularly convenient for a user who uses applications that require authentication throughout use.

As will be appreciated by those skilled in the art, in a secure environment, for example, many applications or components thereof may desire assurances that a user has been authenticated to hold certain rights or be granted access to certain information. Often these applications or components cannot convey rights which have previously been granted, thus, as a result, requiring a re-authentication of the user immediately after a successful authentication. The present embodiments advantageously reduce a number of “re-authentications.” Faster access to applications that authenticate may also be provided.

If, for example, the threshold time period expires (Block 74), the processor 22 prompts the user to again position the user's finger 40 on the finger sensor 30 (Block 76). As noted above, the threshold time period may be set to thirty seconds, for example. The threshold time period may be set based upon a desired level of security. For example, if a higher level of security is desired for a given application, the threshold time period may be set to ten seconds, or if more convenience is desired the threshold time period could be set to a minute or longer. After prompting, and acquisition of new finger-matching finger biometric data, the processor 22 again authenticates the user based upon the newly acquired as described above (Block 68). The authentication method ends at Block 78.

It should be understood that while the embodiments described may be particularly useful for both enrollment and matching operations, the matching operations may be performed independently of the enrollment operations, and vice versa. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An electronic device comprising:
a finger sensor to sense a user's finger; and
a processor to
perform a plurality of applications,
acquire finger-matching biometric data of the user's finger from said finger sensor,
authenticate the user based upon a match between the acquired finger-matching biometric data and finger-enrollment biometric data,
start a given application, from among the plurality thereof, based upon the authentication, and
treat the authentication as valid for a threshold time period.

2. The electronic device of claim 1, wherein said processor is to treat the authentication as valid for the threshold time period while performing the given application.

3. The electronic device of claim 1, wherein said processor is to treat the authentication as valid for the threshold time period while performing an application other than the given application.

4. The electronic device of claim 1, further comprising a finger-operated input device carrying said finger sensor; wherein said processor is to perform at least one device function responsive to operation of said finger-operated input device; and wherein said processor is to acquire the finger-matching biometric data from said finger sensor also responsive to operation of said finger-operated input device.

5. The electronic device of claim 4, wherein said finger-operated input device comprises a pushbutton switch.

6. The electronic device of claim 1, wherein the threshold time period is less than or equal to 30 seconds.

7. The electronic device of claim 1, further comprising a display; and wherein said processor is to prompt, via said display, the user to again position the user's finger on said finger sensor after expiration of the threshold time period.

8. The electronic device of claim 1, wherein said processor is to also acquire the finger-enrollment biometric data.

9. The electronic device of claim 1, further comprising wireless communications circuitry coupled to said processor and to perform at least one wireless communications function.

10. The electronic device of claim 1, wherein said processor is to start the given application communicate using based upon the authentication of a specific finger of the user.

11. The electronic device of claim 1, further comprising a portable housing carrying said finger sensor and said processor.

12. An electronic device comprising:
a portable housing;
a finger-operated input device carried by said portable housing;
a finger sensor carried by said finger-operated input device to sense a user's finger; and
a processor to
perform at least one device function responsive to operation of said finger-operated input device,
perform a plurality of applications,
acquire finger-matching biometric data of the user's finger from said finger sensor also responsive to said finger-operated input device,
authenticate the user based upon a match between the acquired finger-matching biometric data and finger-enrollment biometric data,
start a given application, from among the plurality thereof, based upon the authentication, and
treat the authentication as valid for a threshold time period.

13. The electronic device of claim 12, wherein said processor is to treat the authentication as valid for the threshold time period while performing the given application.

14. The electronic device of claim 12, wherein said processor is to treat the authentication as valid for the threshold time period while performing an application other than the given application.

15. The electronic device of claim 12, wherein said finger-operated input device comprises a pushbutton switch.

16. The electronic device of claim 12, wherein the threshold time period is less than or equal to 30 seconds.

17. A method of authenticating a user of an electronic device comprising a finger sensor, and a processor coupled thereto, the method comprising:
using the processor to
perform a plurality of applications,
acquire finger-matching biometric data of the user's finger from the finger sensor,
authenticate the user based upon a match between the acquired finger-matching biometric data and finger-enrollment biometric data,
start a given application, from among the plurality thereof, based upon the authentication, and
treat the authentication as valid for a threshold time period.

18. The method of claim 17, wherein using the processor comprises using the processor to treat the authentication as valid for the threshold time period while performing the given application.

19. The method of claim 17, wherein using the processor comprises using the processor to treat the authentication as valid for the threshold time period while performing an application other than the given application.

20. The method of claim 17, wherein using the processor further comprises using the processor to perform at least one device function responsive to operation of a finger-operated input device carrying the finger sensor, and to acquire the finger-matching biometric data from the finger sensor also responsive to operation of the finger-operated input device.

21. The method of claim 20, wherein the finger-operated input device comprises a pushbutton switch.

22. The method of claim 17, wherein the threshold time period is less than or equal to 30 seconds.

23. The method of claim 17, using the processor comprises using the processor to prompt, via a display, the user to again position the user's finger on the finger sensor after expiration of the threshold time period.

24. The method of claim 17, wherein using the processor comprises using the processor to also acquire the finger-enrollment biometric data.
